(19) United States
(12) Patent Application Publication
(10) Pub. No.: US 2014/0284900 A1
(43) Pub. Date: Sep. 25, 2014

(54) STEERING SYSTEM FOR TRAILERS

(71) Applicants: Hans Prem, Aspendale Gardens (AU); Kinh-Luan Viet Mai, Vermont South (AU)

(72) Inventors: Hans Prem, Aspendale Gardens (AU); Kinh-Luan Viet Mai, Vermont South (AU)

(73) Assignee: MECHANICAL SYSTEM DYNAMICS PTY LTD, Aspendale Gardens (AU)

(21) Appl. No.: 14/348,888

(22) PCT Filed: Oct. 1, 2012
(86) PCT No.: PCT/AU2012/001196

§ 371 Date: Mar. 31, 2014

(30) Foreign Application Priority Data
Sep. 30, 2011 (AU) 2011904056

(51) Int. Cl. B60D 1/30

(52) U.S. Cl. CPC B60D 1/30
USPC 280/426

(57) ABSTRACT

A method of controlling a combination vehicle for road transport of heavy goods, said vehicle comprising a motor vehicle at the front and a trailer attached so as to be towed behind the motor vehicle, said trailer comprising:
(a) a semi-trailer body adapted to carry goods,
(b) a dolly mounted beneath the front of the semi-trailer body and connected to the semi-trailer body by a pivoting connection, said dolly comprising road wheels attached in one or more axle sets to a dolly frame, each axle set extending across the dolly frame, and
(c) a drawbar assembly connecting the dolly frame to a preceding vehicle unit by means of a trailer coupling assembly,
wherein:
(i) the drawbar assembly defines an instant centre of rotation for the dolly which is located forwards of said trailer coupling assembly while the vehicle is moving forwards at high road speeds, and
(ii) the drawbar assembly defines an instant centre of rotation for the dolly which is located at least substantially at the trailer coupling assembly while the vehicle is moving forwards at low road speeds.

### FIELD OF THE INVENTION

This invention concerns steering systems for trailers that form part of heavy goods vehicles.

### BACKGROUND TO THE INVENTION

A significant problem exists in the dynamic stability of single and multiple trailers being towed one behind the other in truck-trailer and road train configurations. These vehicles are commonly referred to as combination vehicles, typically comprising either a rigid truck or prime mover and one or more semi-trailers and converter dollies.

In this specification the following explanations apply to certain terms:

a) A “heavy goods combination vehicle” is a heavy goods or road transport vehicle with at least one articulation point.

b) A “semi-trailer” is a towed vehicle unit of a heavy goods combination vehicle whose means of attachment to the preceding vehicle unit (a prime mover, another semi-trailer, or a converter dolly) results in some of its vertical load being imposed on said preceding unit through a tow coupling and whose rear is supported by a single axle or multiple axle bogie (tandem, tri, quad, etc.) located towards the rear.

c) A “multiple axle bogie” may be a tandem, tri or quad configuration having respectively two, three or four axles.

d) A “converter dolly” (also called a “dolly”) is a towed vehicle unit of a heavy goods combination vehicle whose tow coupling to the preceding vehicle unit (a rigid truck, a prime mover or another semi-trailer) results in little or none of its vertical load being imposed on said preceding vehicle unit through the tow coupling device (see below) and whose rear is supported by a single axle or multiple axle bogie located at or near to the centre of the main load carrying area. The main load bearing or carrying area of a converter dolly usually incorporates a tow coupling device (fifth wheel coupling or ballrace turntable) so that the dolly may be mounted beneath the front of a semi-trailer body, thereby converting the semi-trailer into a “trailer”. In some countries a converter dolly is also known as a pivoting bogie, a dolly truck or a special truck. A converter dolly may also be adapted to carry goods.

e) A “trailer” in a heavy goods combination vehicle is a towed vehicle unit that can be either a semi-trailer, or a combination of a converter dolly plus a semi-trailer, or a converter dolly adapted to carry goods (also referred to as a “pig trailer”).

f) A “dog trailer” is a trailer with two axle groups of which the front axle group is steered by connection to the preceding vehicle unit by way of a drawbar assembly.

g) A “motor vehicle” in a heavy goods combination vehicle is a vehicle unit which is motorized for propulsion and is built to tow one or more trailers. One of the trailers may be a powered trailer. A motor vehicle can be a prime mover or a rigid truck.

h) A “powered trailer” in a heavy goods combination vehicle is a trailer with a largely self-contained means of generating propulsion through one or more of its wheels. In a combination vehicle one or more of the trailers may be a powered trailer.

i) A “prime mover” is a vehicle unit of a heavy goods combination vehicle built to tow a semi-trailer or a converter dolly. A prime mover may also carry a load.

j) A “rigid truck” is a non-articulated motor vehicle built to carry a load and, in a heavy goods combination vehicle, tow a trailer.

k) A “vehicle unit” is either a trailer, a semi-trailer, a converter dolly, a motor vehicle, or a powered trailer. Thus a combination vehicle has a plurality of such vehicle units connected by an articulated coupling between each adjacent vehicle unit.

l) A “coupling” is a mechanical assembly which provides connection between one vehicle unit (the leading vehicle unit) and another vehicle unit (the trailing vehicle unit) immediately behind. Typically a first part of the coupling is affixed to the leading vehicle unit, a second part of the coupling is affixed to the trailing vehicle unit and the first and second parts are releasably or permanently connected.

m) A “coupling assembly” is an assembly of one or more couplings which connect a drawbar assembly to a vehicle unit immediately in front.

n) A “drawbar assembly” is the portion of a dolly that connects the dolly's frame to the vehicle unit in front for towing purposes.

o) A “ball joint” is a joint comprising a ball and complementary body which clamps only on the outer surface of the ball and rotates freely about the ball centre.

p) A “ringfeder” is a generic name (previously a trademark) commonly used worldwide to identify a type of automatic bolt coupling device (pin-type hitch) utilizing a swivelable cast bell portion with a horizontal opening and a machined pin which connects to a towing eye located on the front of a drawbar assembly. The connection between the towing eye and the pin is a “rotationally free joint” equivalent to a ball joint. The hitch point of a ringfeder coupling is at the longitudinal axis of the pin which engages with the towing eye of the drawbar.

q) A “road train” is a combination of vehicle units, consisting of a motor vehicle towing at least two trailers (counting as one trailer a converter dolly supporting a semi-trailer).

r) A “rotationally free joint” refers to the type of joint which allows the two parts that it connects to have angular freedom (or flex) relative to each other, about one, two or three mutually perpendicular axes without any significant longitudinal, vertical or lateral flexibility. Examples are the type generally referred to as a revolute joint (angular freedom about one axis), Universal or Hookes'/Cardan joint (angular freedom about two mutually perpendicular axes), and a ball joint (angular freedom about three mutually perpendicular axes), or similar which provide a degree of angular flexibility.

In typical prior art configurations of heavy goods combination vehicles that feature a converter dolly, the drawbar has a single coupling connected at the centre of the rear of the towing vehicle unit well rearwards of the centre of the rear axle group on the towing vehicle. This means the Instant Centre of Rotation (the IC) of the converter dolly when taken in plan view relative to the towing vehicle is likewise located well rearwards of the centre of the rear axle group on the towing vehicle.

A dynamic characteristic unique to such prior art combination vehicles that feature converter dollies is a tendency in a steering maneuver for each trailer in the combination to experience a higher level of lateral acceleration than the unit preceding it. This is referred to as “rearward amplification” and is a serious safety issue particularly in rapid path-change maneuvers or abrupt steering events at the truck or prime mover.

The hitch point of a coupling between a truck and trailer is conventionally located some distance rearward of the centre of the rear axle group. That distance is commonly referred to as the “coupling rear overhang”. For combination vehicles having conventional dollies attached to such couplings, at the commencement of a high-speed turn, the tow coupling point, which is at the hitch point, moves laterally in a direction opposite to that of the turn. In a conventional dolly arrangement this causes the dolly to initially turn and move in a direction opposite the intended turn direction. A short time later, as part of the normal sequence of events associated with the turn, the tow coupling point then moves in the direction of the turn causing the dolly frame to be steered in the desired turn direction. This abrupt change of direction of the dolly associated with the initial reverse steer described above, sometimes referred as “whip”, is the basis of the rearward amplification mechanism which occurs in road trains and rigid truck and trailer combinations.

With conventional designs of dollies, rearward amplification decreases with fewer articulation points and is strongly influenced by a range of mechanical properties, including trailer and dolly wheelbase dimensions, the type of couplings between vehicle units and the location of those couplings, tire cornering stiffness, suspension mechanical properties, centre-of-gravity height and all-up weight.

Many complex and expensive mitigation means have been proposed but an aim of the present invention is to provide a relatively low cost means of altering the steering of the dollies of such trailers at medium to high road speeds in order to reduce rearward amplification and allow safe transport of current and greater loads in trailers.

The present invention shifts the IC to a position forwards from the hitch point to improve the dynamic performance at medium to high road speeds. In some embodiments the invention provides for the IC to be moved to the hitch point for reversing of the combination vehicle and, optionally, for low speed forwards travel of the vehicle.

Within this specification the term low speed forwards travel is intended to mean a speed of not greater than 60 kph and preferably less than 40 kph whereas medium to high road speeds means greater than 60 kph and preferably greater than 80 kph.

### SUMMARY OF THE INVENTION

In one aspect the invention provides a combination vehicle for road transport of heavy goods, said vehicle comprising a motor vehicle at the front and a trailer attached so as to be towed behind the motor vehicle, said trailer comprising:
a semi-trailer body adapted to carry goods,
a dolly mounted beneath the front of the semi-trailer body and connected to the semi-trailer body by a pivoting connection, said dolly comprising road wheels attached in one or more axle sets to a dolly frame, each axle set extending across the dolly frame, and
a drawbar assembly connecting the dolly frame to a preceding vehicle unit,

wherein:
the drawbar assembly comprises a plurality of elongate links,
the rear end of each said link is fastened to the dolly frame by a respective rotationally free joint at a respective dolly connection, said dolly connections being spaced from each other,
the front end of each said link is fastened to the rear of a preceding vehicle unit by a respective rotationally free joint at a respective leading connection on said preceding vehicle unit, said leading connections being spaced from each other to thereby collectively form a trailer coupling assembly,
said drawbar assembly defines for said coupling assembly an instant centre of rotation located forwards of said trailer coupling assembly,
a first said elongate link is fastened to the dolly frame at a first said dolly connection, and fastened to said preceding vehicle unit at a first said leading connection,
a second said elongate link is fastened to the dolly frame at a second said dolly connection and fastened to said preceding vehicle unit at a second said leading connection,
a third said elongate link connects said first dolly connection or dolly frame to said second leading connection, and
said third elongate link and at least one of said first and second elongate links may be switched from a mode which is longitudinally rigid to a mode which is longitudinally flexible.

The dolly may have only one axle set. Alternatively the dolly may have two axle sets, one of which is a self-steering axle set and the other of which is not a self-steering axle set. Alternatively the dolly may have three axle sets and the front and/or rear one of said three is not a self-steering axle set while the remaining two of said three are self-steering axle sets.

In another aspect the invention provides a combination vehicle for road transport of heavy goods, said vehicle comprising a motor vehicle at the front and a trailer attached so as to be towed behind the motor vehicle, said trailer comprising:
a semi-trailer body adapted to carry goods,
a dolly mounted beneath the front of the semi-trailer body and connected to the semi-trailer body by a pivoting connection, said dolly comprising road wheels attached in one or more axle sets to a dolly frame, each axle set extending across the dolly frame, and
a drawbar assembly connecting the dolly frame to a preceding vehicle unit,

wherein:
the drawbar assembly comprises a pair of elongate outer links and an elongate inner link,
the rear end of each said outer link is fastened to the dolly frame by a respective rotationally free joint at a respective dolly connection, said dolly connections being spaced from each other,
the front end of each said outer link is fastened to the rear of a preceding vehicle unit by a respective rotationally free joint at a respective leading connection on said preceding vehicle unit, said leading connections being spaced from each other, to thereby collectively form a trailer coupling assembly, and
the front end of said inner link is fastened to the front of a first of said outer links by a rotationally free joint and the rear end of said inner link is fastened to the rear of the second of said outer links or dolly frame by a rotationally free joint.

A first of said outer links may be fastened to the dolly frame at a first said dolly connection, and fastened to said preceding vehicle unit at a first said leading connection, the second of said outer links may be fastened to the dolly frame at a second said dolly connection and fastened to said preceding vehicle unit at a second said leading connection, and said inner link may connect said first dolly connection or dolly frame to said second leading connection.

During high speed forwards travel of the vehicle the outer links may be maintained longitudinally rigid and said inner link maintained as longitudinally flexible, and during reversing of the vehicle the inner link is maintained longitudinally rigid and one of the outer links is maintained as longitudinally flexible.

During low speed forwards travel of the vehicle the inner link may be maintained longitudinally rigid and one of the outer links maintained as longitudinally flexible.

In a further aspect the invention provides a method of controlling a combination vehicle for road transport of heavy goods, said vehicle comprising a motor vehicle at the front and a trailer attached so as to be towed behind the motor vehicle, said trailer comprising:
a semi-trailer body adapted to carry goods,
a dolly mounted beneath the front of the semi-trailer body and connected to the semi-trailer body by a pivoting connection, said dolly comprising road wheels attached in one or more axle sets to a dolly frame, each axle set extending across the dolly frame, and
a drawbar assembly connecting the dolly frame to a preceding vehicle unit by means of a trailer coupling assembly,

wherein:
the drawbar assembly defines an instant centre of rotation for the dolly which is located forwards of said trailer coupling assembly while the vehicle is moving forwards at high road speeds, and
the drawbar assembly defines an instant centre of rotation for the dolly which is located at least substantially at the trailer coupling assembly while the vehicle is moving forwards at low road speeds.

### BRIEF DESCRIPTION OF THE DRAWINGS

In order that the invention may be more fully understood there will now be described, by way of example only, preferred embodiments and other elements of the invention with reference to the accompanying drawings where:

FIG. 1 is a side view of a heavy goods combination vehicle comprising a truck-trailer combination according to a first embodiment of the invention;

FIG. 2 is an enlarged side view of portion of the combination of FIG. 1;

FIG. 3 is a side view of a road train comprising a truck with two trailers incorporating another embodiment of the invention;

FIG. 4 is a plan view looking down on the drawbar assembly shown in FIG. 2;

FIGS. 5, 6 and 7 show the drawbar of FIG. 4 in different positions while the heavy goods combination vehicle is moving forwards at low or high speeds;

FIGS. 8, 9 and 10 show the drawbar of FIG. 4 in different positions while the heavy goods combination vehicle is reversing or moving forwards at low speed;

FIG. 11 is a side view of a heavy goods combination vehicle according to another embodiment of the invention;

FIG. 12 is a plan view showing the drawbar assembly and dolly in the vehicle in FIG. 11;

FIG. 13 is a side view of a heavy goods combination vehicle according to another embodiment of the invention;

FIG. 14 is a plan view showing the drawbar assembly and dolly in the vehicle in FIG. 13; and

FIG. 15 is a plan view showing the drawbar assembly and dolly of a heavy goods combination vehicle according to another embodiment of the invention;

### DESCRIPTION OF THE PREFERRED EMBODIMENT AND OTHER EXAMPLES OF THE INVENTION

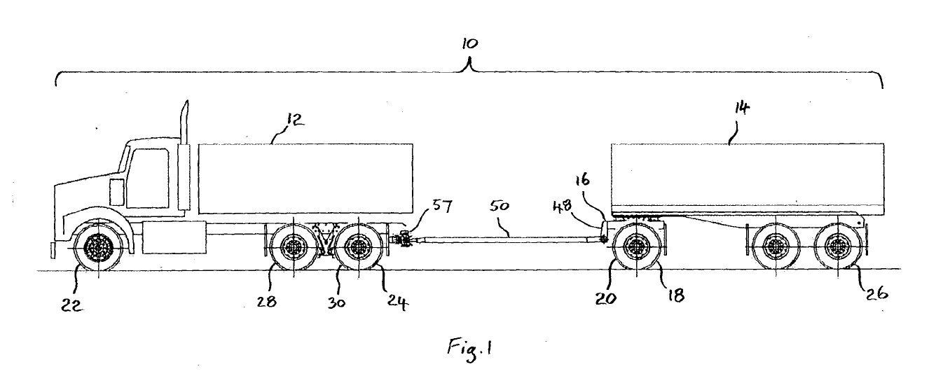

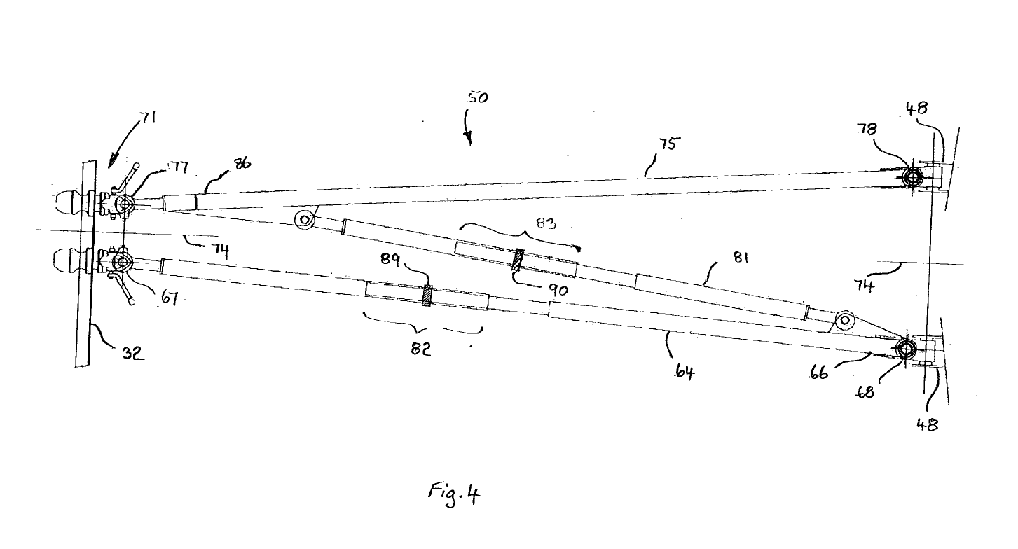

The combination vehicle 10 in FIGS. 1 to 3 is a road transport vehicle comprising a rigid truck 12 plus a single semi-trailer 14 and a single-axle dolly 16. The truck 12 has a pair of steering wheels 22 and a double-axle (tandem) rear axle group 24 comprising a front axle set 28 and a rear axle set 30. The dolly 16 has a drawbar assembly design as shown in FIG. 4. The semi-trailer 14 has its front supported by the dolly 16 and its rear supported by a double-axle rear axle group 26. The semi-trailer 14 and dolly 16 together form a dog trailer 17. The axle groups 24 and 26 are conventional axle groups with no steering capability. A main longitudinal axis 74 runs the length of the vehicle 10 when the vehicle is traveling straight ahead.

The dolly 16 comprises four road wheels 18 on a single axle set 20 attached to the dolly frame 48. The axle set 20 extends across the dolly frame in a direction transverse to the normal direction of travel of the trailer and thus transverse to axis 74.

The dolly frame 48 pivots around a vertical axis 53 relative to the semi-trailer 14 by means of a tow coupling commonly referred to as a ball race turntable 54. The dolly frame 48 is attached to the truck 12 by a drawbar assembly 50 which comprises two elongate link members 64 and 75 arranged symmetrically about the main longitudinal axis 74. The left hand side link 64 is connected to the chassis 32 of the truck by a rotary joint 67 and is connected to the dolly frame 48 by a rotary joint 68. The right hand side link 75 is connected to the truck chassis 32 by a rotary joint 77 and to the dolly frame 48 by a rotary joint 78. A cross-link 81 with rotationally free joints at each of its ends extends from the front end 86 of the right hand side link 75 to the rear end 66 of the left hand side link 64. In an alternative embodiment the cross-link 81 could be connected at its ends direct to the rotary joints 68 and 77 instead of via the respective links 64 and 75. In a further alternative embodiment cross-link 81 could be connected at the dolly end direct to the dolly chassis 48 near to rotary joint 68.

Suitable rotationally free joints include ball joints and so-called universal couplings, also known as Hooke's or Cardan joints. For convenience the term “rotary joint” is sometimes used in this specification when referring to a rotationally free joint.

Both the rotary joints 68 and 78 are rigidly fixed relative to the dolly frame 48 while both the rotary joints 67 and 77 are rigidly fixed relative to the rear of the truck. The rotary joints 67 and 77 in this embodiment are each a Rockinger 50 mm standard coupling. Unlike a Ringfeder coupling described above, the bell mouth (or funnel) of the Rockinger coupling is a moving part and it also swivels on the coupling pin axis. The funnel can be removed, which is how the couplings 67 and 77 are shown in FIG. 4.

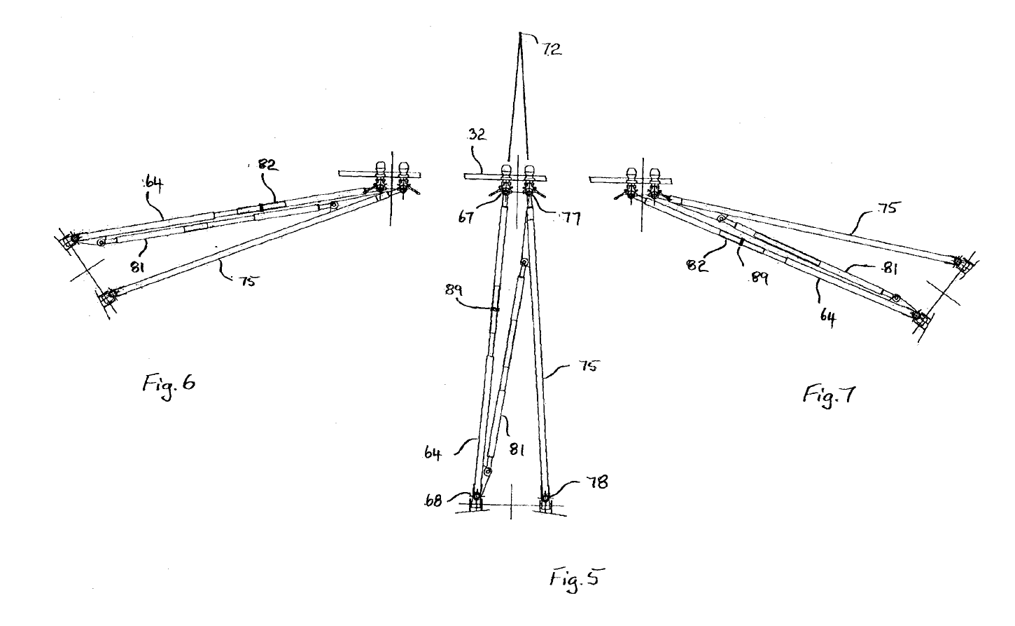

As a result of the geometry of the drawbar assembly, the IC of the relative motion of the truck and the dolly is moved forward of the joints 67 and 77 (which together form the trailer coupling assembly 71) to the point 72 shown on FIG. 5. Substantial sophisticated numerical modeling by the present inventors indicates that the best performance occurs when the IC lies between the joints 67 and 77 on the truck and the lead axle 28 in the axle group at the rear of the truck. If there is only a single axle at the rear of the truck, then the best performance occurs when the IC is positioned between the hitch point and a point which is forward of the single axle up to a distance equal to the distance between the single axle and the hitch point.

The link member 75 is completely rigid and of non-adjustable fixed length but the link member 64 and cross-link member 81 each have a telescoping portion 82 and 83 respectively so that the length of those links may be varied. The telescoping section 82 on link 64 carries a locking device 89 and the telescoping section 83 on cross-link 81 carries a locking device 90. The telescoping sections 82 and 83 are free to slide and so vary the length of the respective links 64 and 81 unless the respective locking device 89 or 90 is engaged which then locks the length of the respective link at a single predetermined length. In use, only one of the locking devices is activated at any time so that one and only one of links 64 and 81 are free to telescope at any time. Which locking device is activated and which is deactivated is determined by the manner in which the vehicle is to be used.

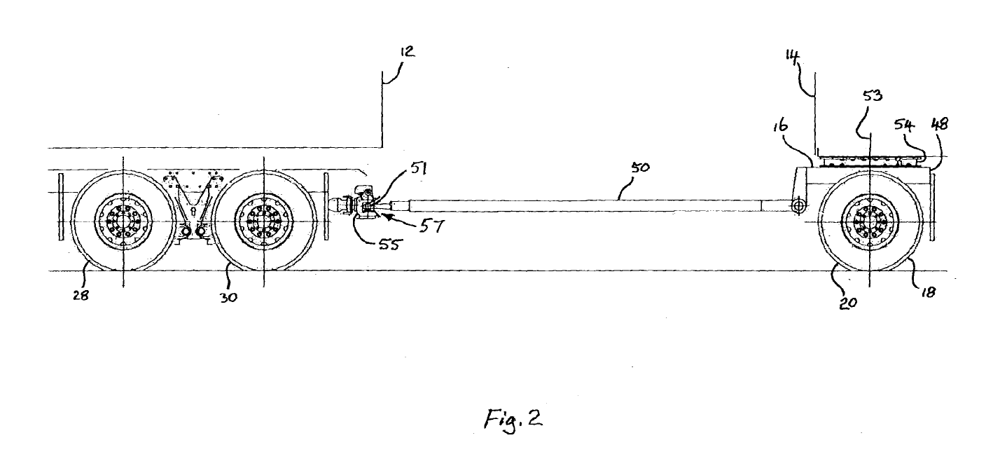

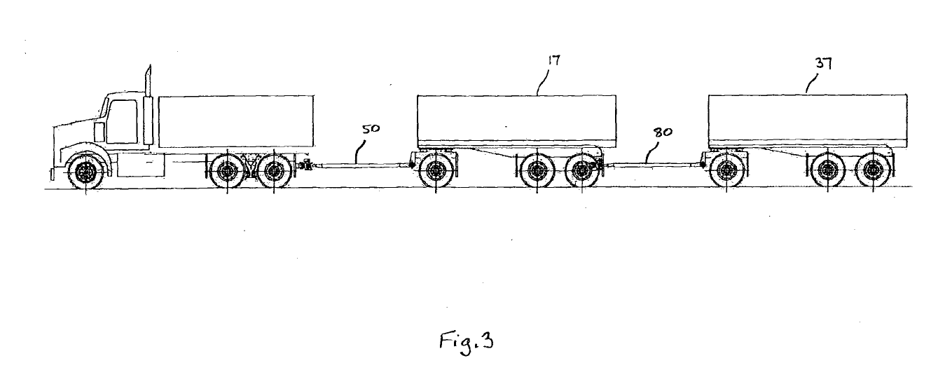

As seen in FIG. 2 the links 64, 75 and 81 are all in the same horizontal plane when the truck 12 and trailer 17 are on a horizontal surface. While such a horizontally aligned relationship can limit the angle through which the articulation can turn horizontally, with appropriate spacing of the links, the turning limitations need not be particularly restrictive. However if an increased angle is required, the links 64, 75 and 81 may be positioned so their axes lie in two or three vertically separated planes and, if necessary, both vertically separated and angled planes.

Where more than one trailer is being towed, one behind the other, a similar steering arrangement can be incorporated in each dolly and the descriptions presented above between the motor vehicle and the first trailer can be applied equally between each pair of trailers. The road train combination vehicle shown in FIG. 3 would have a particularly poor high-speed performance using conventional drawbar assembly configurations and coupling assemblies to attach the dog trailers 17 and 37. The performance would be unacceptable due to rearward amplification. This performance would deteriorate markedly again if a third similar trailer was added to the road train.

It is particularly important that the drawbar assembly 50 on the leading trailer 17 should be in accordance with the present invention. It is preferred that the drawbar assembly 80 on the second trailer 37 (and any additional following trailer forming part of a road train) should be in accordance with the present invention, although it is less important for the IC to be positioned within the same location constraints applied to the drawbar assembly on the leading trailer 17. It may be advantageous for the dolly IC of the second trailer 37 (and any additional following trailers in the road train) to be further forward than the lead-axle of the rear-axle group of the preceding trailer, this being the first trailer 17 in FIG. 3.

As shown in FIGS. 5, 6 and 7, when the vehicle 10 is traveling forward at medium to high speed, the locking device 89 is engaged on the left side link 64, and locking device 90 is disengaged on the cross-link 81, so that the cross-link is free to telescope and provides no part in control/steering of the vehicle. The cross-link 81 is shown close to its maximum length in FIG. 6 and close to its minimum length in FIG. 7.

However when reversing the vehicle the locking device 90 on the cross-link 81 is engaged and the locking device 89 on link 64 is disengaged. The link 64 is then free to telescope and thus vary its length and thus takes no part in steering the dolly. The link 64 is shown close to its minimum length in FIG. 9 and close to its maximum length in FIG. 10. The drawbar assembly 50 then performs in a manner equivalent to a conventional A-frame drawbar arrangement and reversing of the vehicle is much easier.

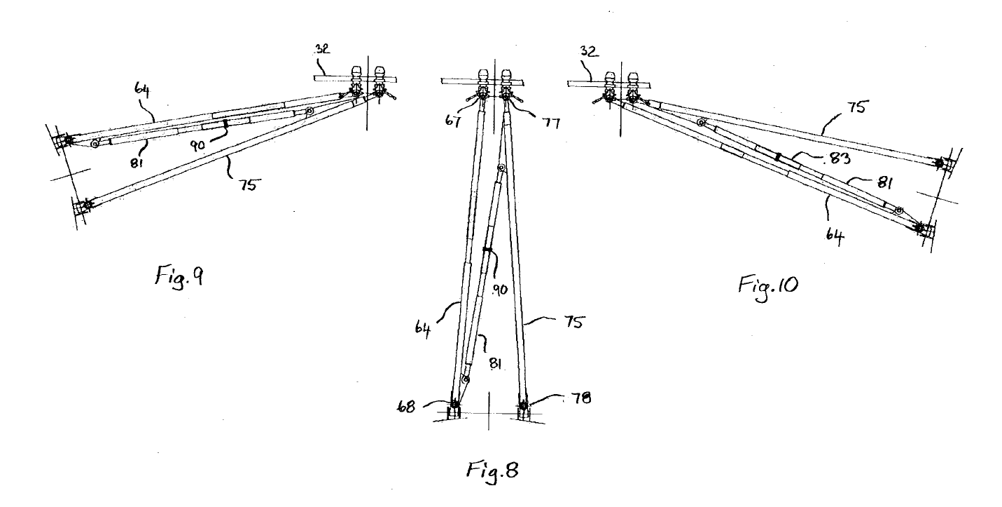

Preferably the locking device 90 is also engaged and the locking device 89 disengaged when the vehicle is traveling forwards at low speeds so the configuration is locked as shown in FIGS. 8 to 10. This provides the added benefit of reducing low-speed off-tracking (swept path) when compared with the operation of the same vehicle with the links locked as shown in FIGS. 5 to 7. This would be of advantage where there is limited space to maneuver the vehicle.

The locking devices may be simple tapered cylindrical pins or bolts that have a taper-ended flat plate in form. The locking devices 89 and 90 can be air operated or driven by small electric or hydraulic motors. The actuation of the devices may be automatic depending on vehicle speed and/or the gearbox gear selection. Alternatively the actuation of the devices may be manually selected by the driver but with appropriate interlocks to prevent the wrong selection at an inappropriate occasion. It may be necessary to move the vehicle slightly forward or in reverse in order to allow the relevant pin(s) to engage/disengage.

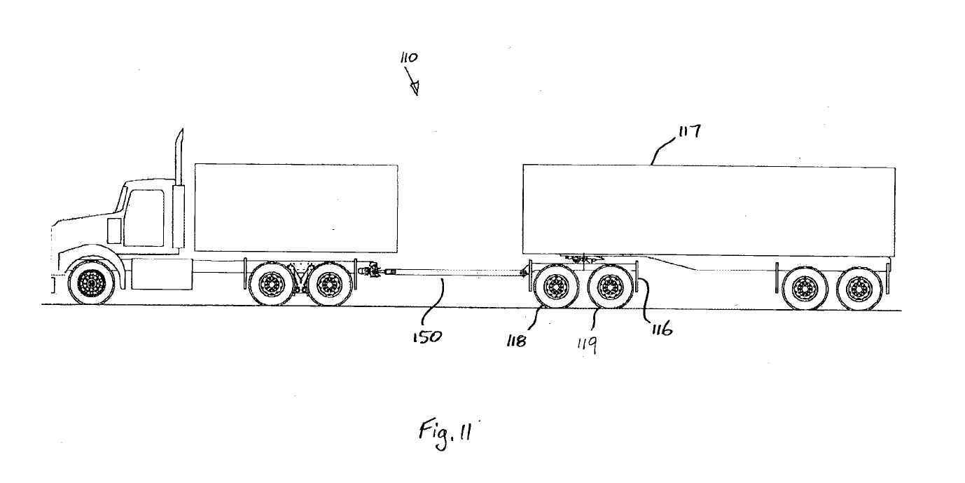

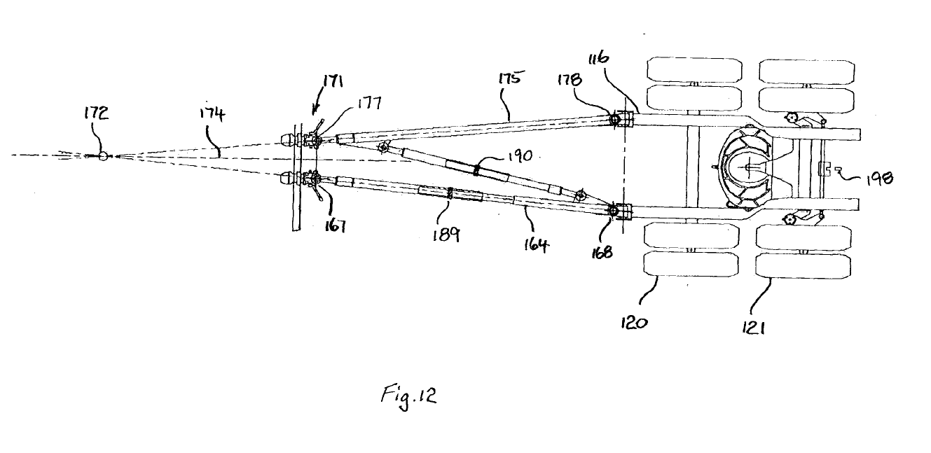

The combination vehicle 110 shown in FIGS. 11 and 12 is substantially the same as the vehicle 10 in FIG. 1 except that the semi-trailer 117 is longer and a tandem axle dolly 116 is used to take the additional load that may be carried by the trailer. The drawbar assembly 150 has the same configuration as that in FIG. 4. While the front axle set 120 on the dolly 116 is a conventional non-steered axle, the rear axle set 121 is a self-steered axle. Thus while the road wheels 118 on the axle set 120 always remain parallel to the longitudinal direction of the dolly, the road wheels 119 on the rear axle set 121 will self-steer in the manner well known for self-steered axles. This combination of a non-steered axle and a self-steered axle can be used to effect a further small reduction in swept path width and reduces stresses imparted to the tires and components in the drawbar.

Having a self-steered axle located at the rear of a tandem dolly provides improved low speed forward travel of the vehicle but it is non-conventional because it reduces tire side force capability which normally imparts adverse dynamic vehicle behavior at high speed. Alternatively the self-steered axle may be located in front of the non-steered axle. The self-steered axle is beneficially provided with a locking mechanism 198 whereby the self-steering mechanism is selectively disabled such that the road wheels thereon remain parallel to the longitudinal direction of the dolly for the time the locking mechanism is engaged. The locking mechanism is activated at high forward speed using the same logic controller system used to activate the locking devices 189 and 190 in the drawbar assembly.

The link members 164 and 175 are arranged symmetrically about the main longitudinal axis 174. Due to that symmetrical relationship, the IC 72 is located on the axis 174. The position of the IC may be moved by moving the rotary joints 178 and 168, and/or rotary joints 167 and 177, inwards or outwards relative to the axis 174. The rotary joint 167 and rotary joint 177 in combination form the trailer coupling assembly 171.

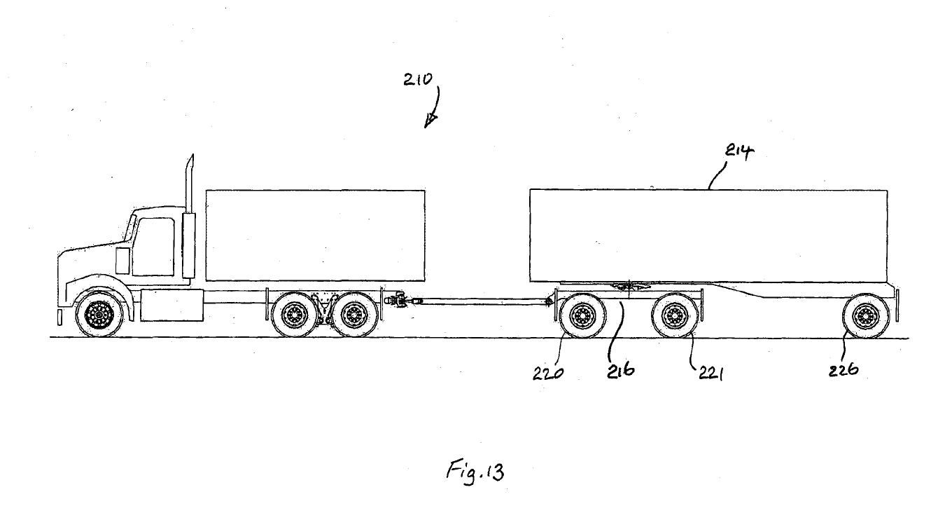

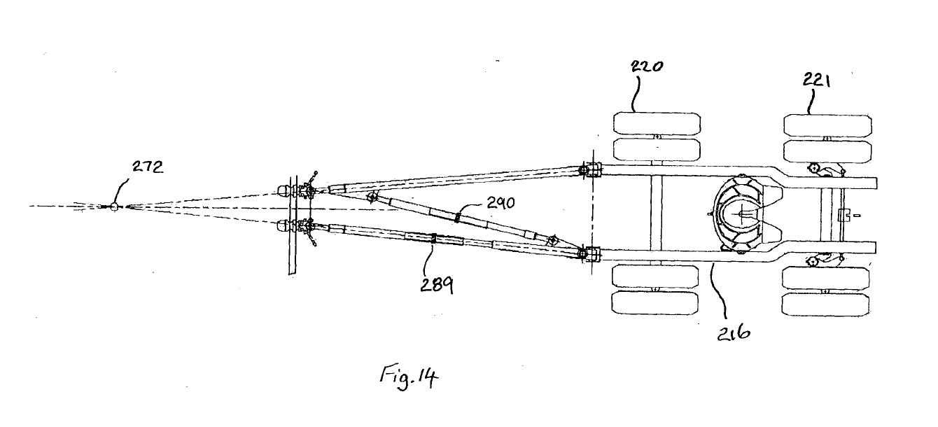

The combination vehicle 210 shown in FIGS. 13 and 14 differs from the vehicle 110 in FIGS. 11 and 12 in that the semi-trailer 214 has only a single axle set 226 at its rear and the tandem axle dolly 216 has its two axle sets 220 and 221 which are much more widely spaced apart than the axle sets on dolly 116. Again the front axle set 220 on the dolly 216 is a conventional non-steered axle and the rear axle set 221 is a self-steered axle. This embodiment provides the advantage that the widespread axles on the dolly can be treated as two single axles and thus be able to carry a greater load under current regulations than would a dolly with standard axle spacing.

Again the self-steered axle 221 is optionally provided with a locking mechanism whereby the self-steering mechanism is selectively disabled at high forward speed such that the road wheels thereon remain parallel to the longitudinal direction of the dolly for the time the locking mechanism is engaged. The locking mechanism may be activated at high forward speed using the same logic controller system used to activate the locking devices 289 and 290 in the drawbar assembly.

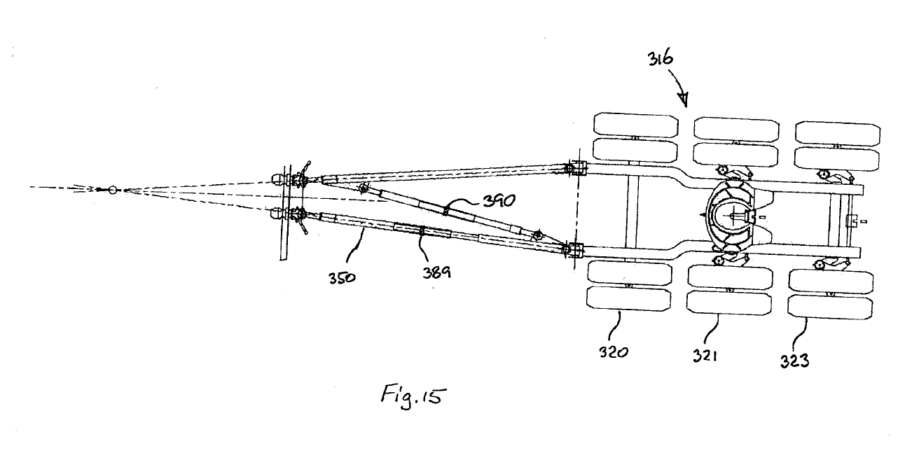

The drawbar assembly 350 shown in FIG. 15 is the same as that in FIG. 14. However and dolly 316 has three axle sets 320, 321 and 323. The front axle set 320 is non-self-steering whereas the rear two sets 321 and 323 are self-steering. The self-steered axle sets are each provided with a locking mechanism whereby the self-steering mechanism may be selectively disabled at high speed such that the road wheels thereon remain parallel to the longitudinal direction of the dolly for the time the locking mechanism is engaged. The locking mechanism is activated using the same logic controller system used to activate the locking devices 389 and 390 in the drawbar assembly.

Sophisticated analysis and numerical modeling by the present applicant has confirmed the improvement in dynamic stability of combination vehicles incorporating the present invention. The invention provides a substantial improvement in the high-speed stability and dynamics of vehicles, with improvements in low speed maneuverability (swept path width).

Retrofitting of the invention is feasible to existing dollies.

While the above description includes the preferred embodiments of the invention, it is to be understood that many variations, alterations, modifications and/or additions may be introduced into the constructions and arrangements of parts previously described without departing from the essential features or the spirit or ambit of the invention.

For example the invention is also applicable with dollies having multiple axles, although it is particularly applicable with dollies having a single axle.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A combination vehicle for road transport of heavy goods, said vehicle comprising a motor vehicle at the front and a trailer attached so as to be towed behind the motor vehicle, said trailer comprising:
(a) a semi-trailer body adapted to carry goods,
(b) a dolly mounted beneath the front of the semi-trailer body and connected to the semi-trailer body by a pivoting connection, said dolly comprising road wheels attached in one or more axle sets to a dolly frame, each axle set extending across the dolly frame, and
(c) a drawbar assembly connecting the dolly frame to a preceding vehicle unit,
wherein:
(i) the drawbar assembly comprises a plurality of elongate links,
(ii) the rear end of each said link is fastened to the dolly frame by a respective rotationally free joint at a respective dolly connection, said dolly connections being spaced from each other,
(iii) the front end of each said link is fastened to the rear of a preceding vehicle unit by a respective rotationally free joint at a respective leading connection on said preceding vehicle unit, said leading connections being spaced from each other to thereby collectively form a trailer coupling assembly,
(iv) said drawbar assembly defines for said coupling assembly an instant centre of rotation located forwards of said trailer coupling assembly,
(v) a first said elongate link is fastened to the dolly frame at a first said dolly connection, and fastened to said preceding vehicle unit at a first said leading connection,
(vi) a second said elongate link is fastened to the dolly frame at a second said dolly connection and fastened to said preceding vehicle unit at a second said leading connection,
(vii) a third said elongate link connects said first dolly connection or dolly frame to said second leading connection, and
(viii) said third elongate link and at least one of said first and second elongate links may be switched from a mode which is longitudinally rigid to a mode which is longitudinally flexible.

2. A combination vehicle according to claim 1 wherein said dolly has only one axle set.

3. A combination vehicle according to claim 1 wherein said dolly has two axle sets, one of which is a self-steering axle set and the other of which is not a self-steering axle set.

4. A combination vehicle according to claim 1 wherein said dolly has three axle sets and the front and/or rear one of said three is not a self-steering axle set while the remaining two of said three are self-steering axle sets.

5. A combination vehicle for road transport of heavy goods, said vehicle comprising a motor vehicle at the front and a trailer attached so as to be towed behind the motor vehicle, said trailer comprising:
(a) a semi-trailer body adapted to carry goods,
(b) a dolly mounted beneath the front of the semi-trailer body and connected to the semi-trailer body by a pivoting connection, said dolly comprising road wheels attached in one or more axle sets to a dolly frame, each axle set extending across the dolly frame,
(c) a drawbar assembly connecting the dolly frame to a preceding vehicle unit,
wherein:
(i) the drawbar assembly comprises a pair of elongate outer links and an elongate inner link,
(ii) the rear end of each said outer link is fastened to the dolly frame by a respective rotationally free joint at a respective dolly connection, said dolly connections being spaced from each other,
(iii) the front end of each said outer link is fastened to the rear of a preceding vehicle unit by a respective rotationally free joint at a respective leading connection on said preceding vehicle unit, said leading connections being spaced from each other, to thereby collectively form a trailer coupling assembly, and
(iv) the front end of said inner link is fastened to the front of a first of said outer links by a rotationally free joint and the rear end of said inner link is fastened to the rear of the second of said outer links or dolly frame by a rotationally free joint.

6. A combination vehicle according to claim 5 wherein:
(a) a first of said outer links is fastened to the dolly frame at a first said dolly connection, and fastened to said preceding vehicle unit at a first said leading connection,
(b) the second of said outer links is fastened to the dolly frame at a second said dolly connection and fastened to said preceding vehicle unit at a second said leading connection, and
(c) said inner link connects said first dolly connection or dolly frame to said second leading connection.

7. A method of controlling a combination vehicle according to claim 6 wherein:
(a) during high speed forwards travel of the vehicle the outer links are maintained longitudinally rigid and said inner link is maintained as longitudinally flexible, and
(b) during reversing of the vehicle the inner link is maintained longitudinally rigid and one of the outer links is maintained as longitudinally flexible.

8. A method according to claim 6 wherein during low speed forwards travel of the vehicle the inner link is maintained longitudinally rigid and one of the outer links is maintained as longitudinally flexible.

9. A method of controlling a combination vehicle for road transport of heavy goods, said vehicle comprising a motor vehicle at the front and a trailer attached so as to be towed behind the motor vehicle, said trailer comprising:
(a) a semi-trailer body adapted to carry goods,
(b) a dolly mounted beneath the front of the semi-trailer body and connected to the semi-trailer body by a pivoting connection, said dolly comprising road wheels attached in one or more axle sets to a dolly frame, each axle set extending across the dolly frame, and
(c) a drawbar assembly connecting the dolly frame to a preceding vehicle unit by means of a trailer coupling assembly,
wherein:
(i) the drawbar assembly defines an instant centre of rotation for the dolly which is located forwards of said trailer coupling assembly while the vehicle is moving forwards at high road speeds, and
(ii) the drawbar assembly defines an instant centre of rotation for the dolly which is located at least substantially at the trailer coupling assembly while the vehicle is moving forwards at low road speeds.

10. A method of controlling a combination vehicle according to claim 5 wherein:
(a) during high speed forwards travel of the vehicle the outer links are maintained longitudinally rigid and said inner link is maintained as longitudinally flexible, and
(b) during reversing of the vehicle the inner link is maintained longitudinally rigid and one of the outer links is maintained as longitudinally flexible.
